(19) United States
(12) Patent Application Publication
(10) Pub. No.: US 2004/0084552 A1
(43) Pub. Date: May 6, 2004

(54) Lawn and garden sprayer

(76) Inventor: Warren Craig Huartson, Harrisburg, NC (US)

Correspondence Address: ADAM EVANS, P.A., (formerly Adams, Schwartz & Evans, P.A.), 2180 TWO WACHOVIA CENTER, CHARLOTTE, NC, 28282, US

(21) Appl. No.: 10/695,162

(22) Filed: Oct. 28, 2003

Related U.S. Application Data
(60) Provisional application No. 60/422,698, filed on Oct. 31, 2002.

(51) Int. Cl. B05B 9/03

(52) U.S. Cl. 239/146; 239/159; 239/332; 239/532; 239/302

(57) ABSTRACT

A lawn and garden sprayer designed for homeowners, landscapers, and lawn-care professionals for the application of liquid organic fertilizers and soil amendments on small to medium sized yards and business landscapes. The lawn and garden sprayer is a lawn mower-like system that holds up to 8 gallons of water soluble fertilizers and soil nutrients which can be dispensed evenly, economically and easily through either two spray nozzles located in front of the front tires which provide a 24 inch overlapping spray directly to the turf, or by a wand sprayer attached to a pump by a 20 foot hose used to spray directly on trees, shrubs, plants, and beds.

### TECHNICAL FIELD AND BACKGROUND OF THE INVENTION

This application claims the benefit of Provisional Application No. 60/422,698 filed on Oct. 31, 2002.

The present invention relates to a lawn mower-like sprayer system designed for homeowners, landscapers, and lawn-care professionals for the application of liquid organic fertilizers and soil amendments on small to medium sized yards and business landscapes around the world.

Within the Lawn and Garden Industry there is a paradigm shift taking place away from a Nitrogen-Phosphate-Potash “NPK” focus to a more safe, non-toxic, and sustainable home/backyard ecosystem. In response to this shift, the primary source of information and development is coming from the agriculture industry where a century of chemical use by farmers has eroded the depth and quality of fertile soil worldwide. Many companies and like minded individuals have developed products for the agriculture industry intent on improving the natural biology of the soil. This has led to increased crop yields and a reduction in the need for fertilizers of all types, along with developing a deeper “living” soil base allowing for larger and deeper root growth which in turn reduces the need for valuable water resources.

Product development of organic fertilizers and amendments for the homeowner market have primarily come from agriculture which relies heavily on water soluble products delivered to the ground and plants by tractors pulling large sprayer tanks. While the small farmer and large homeowner have access to downsized tractors and sprayers, these implements are still too large and cumbersome for most small to medium sized yards.

Currently there is no system available to fit the needs of homeowners with homesites falling in the range of ¼ to ½ acres. Available implements are either too large or too small to be of practical use. On the large end there are several models which are designed to be pulled behind a small lawn tractor. The need to pull is an issue of size and weight. The smallest sprayer system available through regular retail channels is 15 gallons. The total weight of this system fully loaded is over 150 pounds which would prove extremely difficult to maneuver in thick turf without the aid of a tractor. Located at the other end of the spectrum is the 2 gallon backpack sprayer which is completely impracticable for lawn coverage.

The Eco Guardian Lawn and Garden Sprayer answers the general problems found in the marketplace and uniquely packages technology to build a homeowner friendly sprayer system. The Eco Guardian Lawn and Garden Sprayer combines the spraying capabilities for turf, tree, plant, and bed spraying into a push type platform which can be easily used and maintained by men and women of all ages.

### SUMMARY OF THE INVENTION

Therefore, it is an object of the invention to provide a lawn and garden sprayer for small to medium sized yards.

It is another object of the invention to provide a lawn and garden sprayer that can be pushed by men and women of all ages.

It is another object of the invention to provide a lawn and garden sprayer that can be maneuvered in thick turf without the aid of a tractor.

It is another object of the invention to provide a lawn and garden sprayer that allows for complete lawn coverage.

It is another object of the invention to provide a lawn and garden sprayer that can be used to spray directly on trees, shrubs, plants, and beds.

It is another object of the invention to provide a lawn and garden sprayer that can be easily maintained.

These and other objects of the present invention are achieved in the preferred embodiments disclosed below by providing a lawn and garden sprayer including a rigid frame chassis, wherein the chassis has a right horizontal support connected to a right end of a front horizontal support and a right end of a rear horizontal support, a left horizontal support connected to a left end of a front-horizontal support and a left end of a rear horizontal support, a guide bar connected to the right support, the left support, and the rear support by at least one vertical support; a plurality of rear wheels connected to a rear end of the chassis and a plurality of front wheels connected to a front end of the chassis; a power supply, a suction/discharge device, and a container supported by the chassis; and a first and a second means for spraying a liquid substance.

According to another preferred embodiment of the invention, the rear wheels are substantially larger than the front wheels to allow easy movement of the sprayer.

According to another preferred embodiment of the invention, the power supply is a battery and the suction/discharge device is a pump.

According to another preferred embodiment of the invention, the suction/discharge device is connected to the container by at least one hose.

According to another preferred embodiment of the invention, the first means for spraying a liquid comprises at least one spray nozzle.

According to another preferred embodiment of the invention, the spray nozzle is attached to the front end of the chassis and connected to the suction/discharge device by at least one hose.

According to another preferred embodiment of the invention, the second means for spraying a liquid comprises at least one spray wand.

According to another preferred embodiment of the invention, the spray wand is connected to said suction/discharge device by at least one hose.

According to another preferred embodiment of the invention, A lawn and garden sprayer including a rigid uni-body chassis, wherein the chassis has a front side, a rear side, a right side, and a left side defining an interior cavity for supporting a container, a power supply, and a suction/discharge device; a female strengthening ring defined by a top edge of the chassis; a guide bar connected to the right side and the left side of the chassis; a plurality of rear wheels connected to a rear end of the chassis and a plurality of front wheels connected to a front end of the chassis; and a first and a second means for spraying a liquid substance.

According to another preferred embodiment of the invention, the container has a male strengthening ring for mating with the female strengthening ring of the chassis.

According to another preferred embodiment of the invention, the power supply is a battery and the suction/discharge device is a pump.

According to another preferred embodiment of the invention, the rear wheels are substantially larger than the front wheels to allow easy movement of the sprayer.

According to another preferred embodiment of the invention, the suction/discharge device is connected to the container by at least one hose.

According to another preferred embodiment of the invention, the first means for spraying a liquid comprises at least one spray nozzle.

According to another preferred embodiment of the invention, the spray nozzle is attached to the front end of the chassis and connected to the suction/discharge device by at least one hose.

According to another preferred embodiment of the invention, the second means for spraying a liquid comprises at least one spray wand.

According to another preferred embodiment of the invention, the spray wand is connected to the suction/discharge device by at least one hose.

According to another preferred embodiment of the invention, the lawn and garden sprayer further includes a back cover for covering the power supply and the suction/discharge device within the chassis.

According to another preferred embodiment of the invention, the back cover has a male strengthening ring for mating with the female strengthening ring of the chassis.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an environmental view of the Eco-Guardian Lawn and Garden Sprayer

FIG. 2 is a perspective view of a first embodiment of the Eco-Guardian Lawn and Garden Sprayer showing the sprayer from the side.

FIG. 3 is a perspective view of a first embodiment of the Eco-Guardian Lawn and Garden Sprayer showing the sprayer from an angle.

FIG. 4 is a perspective view of the pump, battery, and hoses of the Eco-Guardian Lawn and Garden Sprayer

FIG. 5 is a perspective view of a second embodiment of the Eco-Guardian Lawn and Garden Sprayer showing the sprayer from the side.

FIG. 6A is a perspective view of a side view of a chassis of the second embodiment of the Eco-Guardian Lawn and Garden Sprayer.

FIG. 6B is a perspective view of an end view of a chassis of the second embodiment of the Eco-Guardian Lawn and Garden Sprayer.

FIG. 7A is a perspective view of a side view of a tank of the second embodiment of the Eco-Guardian Lawn and Garden Sprayer.

FIG. 7B is a perspective view of a top view of a tank of the second embodiment of the Eco-Guardian Lawn and Garden Sprayer.

FIG. 7C is a perspective view of a rear view of a tank of the second embodiment of the Eco-Guardian Lawn and Garden Sprayer.

FIG. 8 is a perspective view of a tank within a chassis along with a back cover of the second embodiment of the Eco-Guardian Lawn and Garden Sprayer.

FIG. 9 is a perspective view of the tank within the chassis with a back cover hinged on the chassis of the second embodiment of the Eco-Guardian Lawn and Garden Sprayer.

### DESCRIPTION OF THE PREFERRED EMBODIMENT AND BEST MODE

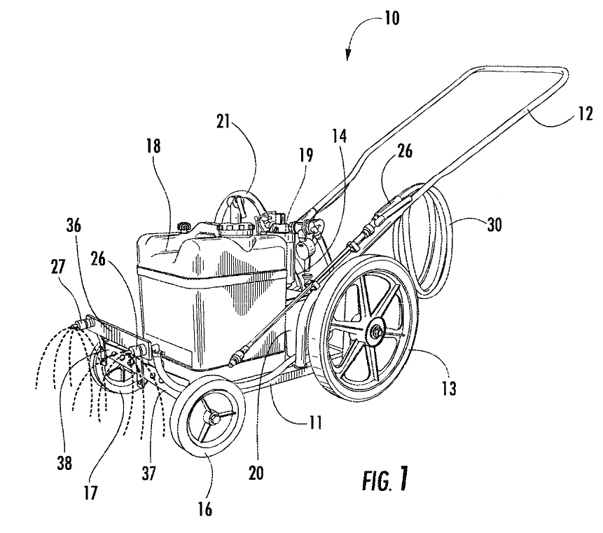

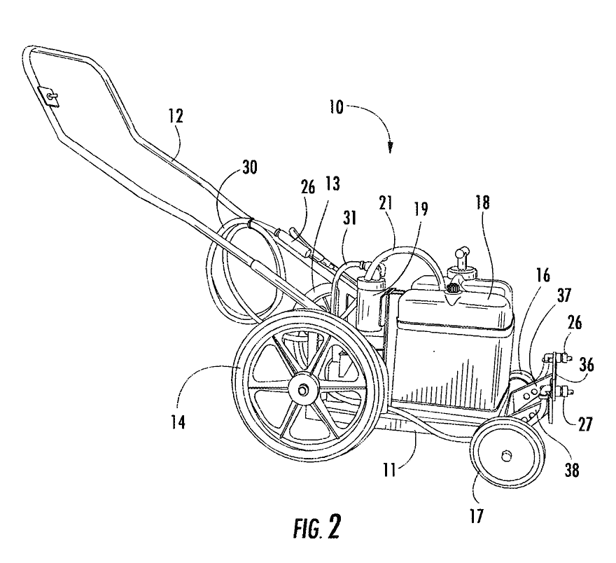

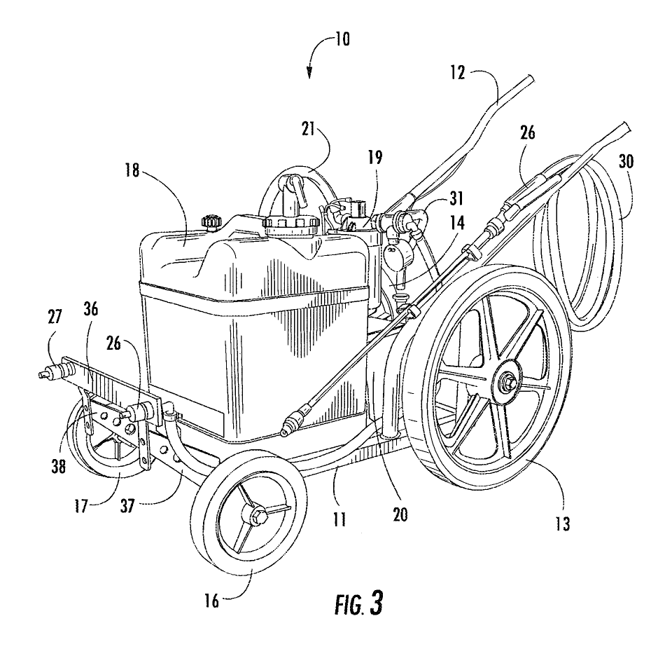

Referring now specifically to the drawings, a Lawn and Garden Sprayer according to the first embodiment of the present invention is illustrated in FIGS. 1-4 and shown generally at reference numeral 10. The lawn and garden sprayer 10 has a rigid frame chassis 11 with a right horizontal support 12 running parallel to a left horizontal support 13. The right horizontal support 12 is connected to a right end of a front horizontal support 14 and a right end of a rear horizontal support 16. The left horizontal support 13 is connected to a left end of the front horizontal support 14 and a left end of the rear horizontal support 16. A guide bar 17 is attached to the left horizontal support 13 and the right horizontal support 14 by two vertical supports 18 and 19 at the rear of the rigid frame chassis 11. The rigid frame chassis 11 is supported by two rear wheels 20 and 21 connected to a rear end of the rigid frame chassis 11 and two front wheels 22 and 23 connected to a front end of the rigid frame chassis 11. The rear wheels 20 and 21 are substantially bigger than the front wheels 22 and 23 to allow easy movement of the lawn and garden sprayer 10 through thick turf. The front wheels 22 and 23 are rigidly fixed to the rigid frame chassis, however, other types of front wheels such as caster wheels can be used. The rigid frame chassis supports a container 24, a suction/discharge device 26 (hereinafter referred to as a pump), and a power supply 27 (hereinafter referred to as a battery). The container 24 preferably has an 8 gallon capacity, but any suitably sized container could be used. The container 24 is easily removed for cleaning, substantially increasing the life of all components associated with the pump 26. The pump 26 is a diaphragm pump such as the 8000 Series Diaphragm Pump sold by SHURflo Pump Manufacturing Company, however, any suitable pump may be used. The battery 27 is a 12 volt battery such as the PS-12280 sold by Power Sonic, however, any suitable power supply may be used.

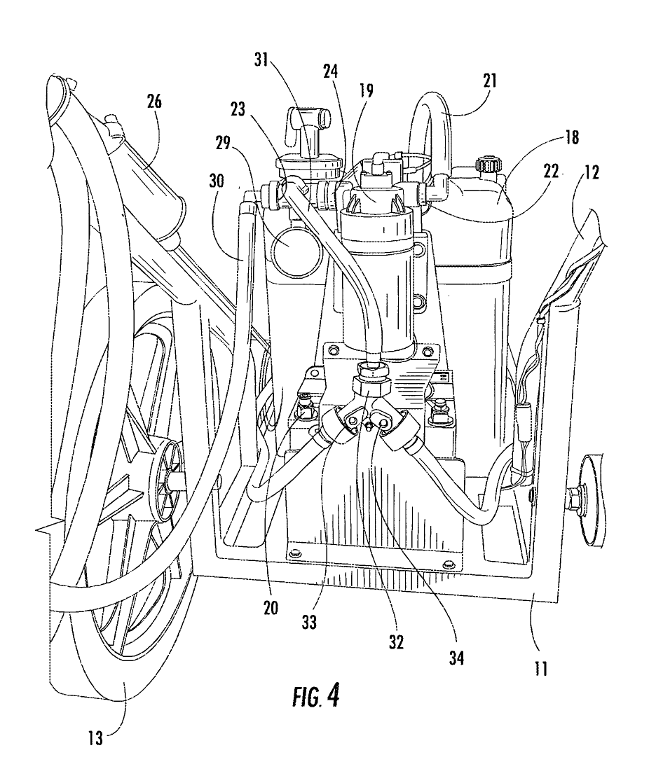

Referring specifically to FIG. 4, a suction hose 28 is connected to the suction port 29 of the pump 26 and runs to the container 24 to allow the pump 26 to remove the water soluble fertilizer, or any other type of liquid, within the container 24. A tee 30 is connected to the discharge port 31 of the pump 26 for allowing the water soluble fertilizer to flow to a wand 32 or to a pair of nozzles 33 and 34. A pressure gage 36 is connected to the tee 30 to allow a user to check the output pressure of the pump 26 to verify the pump 26 is working properly. A wand hose 37 is connected at the end of the tee 30 and runs to a wand 32 for spraying trees, shrubs, and flowers. The wand hose 37 is preferably twenty feet in length, however, any suitable length cold be used. A nozzle hose 38 runs from the center of the tee 30 to a splitter 39. The splitter 39 splits the flow of water soluble fertilizer to the two nozzles 33 and 34. The splitter 39 contains shut off valves 40 and 41 to control the flow of water soluble fertilizer to each of the nozzles 33 and 34. The nozzles 33 and 34 are mounted to the front of the rigid frame chassis 11. The nozzles 33 and 34 are mounted to a plate 42 which is attached to the rigid frame chassis 11 by a pair of outwardly extending arms 43 and 44 (See FIGS. 1-3). The nozzles 33 and 34 are preferably mounted to provide a 24 inch overlapping spray, however, other nozzle spacing could be used to provide a larger or smaller overlapping spray. The flow of water soluble fertilizer to the nozzles 33 and 34 and the wand 32 is controlled by back pressure produced by the closing of valves. When the wand 32 is not in use, it produces a back pressure forcing the water soluble fertilizer to flow towards the nozzles 33 and 34. The amount of water soluble fertilizer flowing to the nozzles 33 and 34 is controlled by the shut off valves 40 and 41. To use the wand 32, the shut off valves 40 and 41 are completely shut off creating a back pressure and forcing the water soluble fertilizer to flow towards the wand 32.

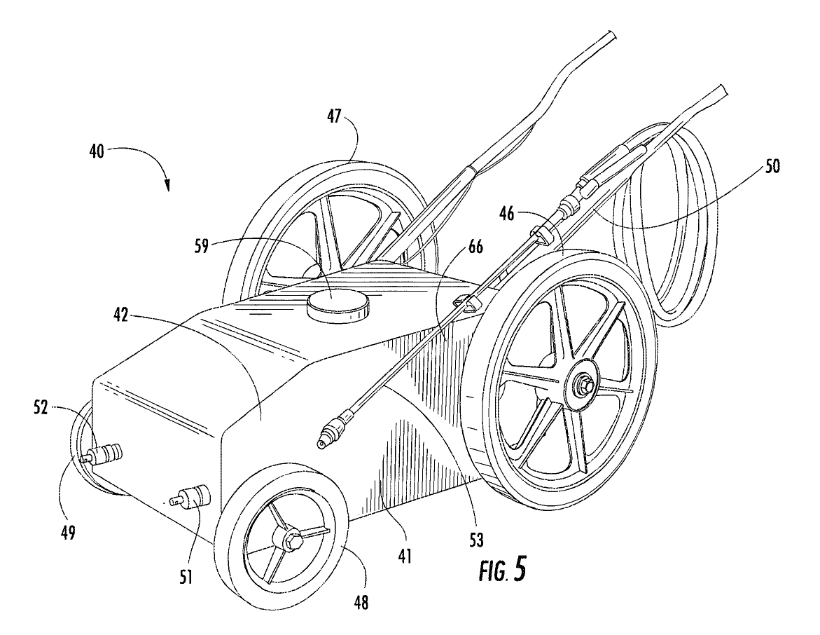

Referring now to FIGS. 5-9, FIGS. 5-9 illustrate a Lawn and Garden Sprayer according to a second embodiment of the invention and is shown generally at reference numeral 50. The Lawn and Garden Sprayer 50 illustrated in FIGS. 5-9 performs and operates in the same manner as the Lawn and Garden Sprayer 10 illustrated in FIGS. 1-4. However, the Lawn and Garden Sprayer 50 is a sleeker, lighter weight, and more compact design.

Referring specifically to FIG. 5, FIG. 5 is an overall side view of the Lawn and Garden Sprayer 50. The Lawn and Garden Sprayer 50 includes a rigid uni-body chassis 51 which supports a container 52, a suction/discharge device 53 (hereinafter referred to as a pump), and a power supply 54 (hereinafter referred to as a battery). The rigid uni-body chassis 51 is supported by two rear wheels 56 and 57 mounted to a rear of the rigid uni-body chassis 51 and two front wheels 58 and 59 mounted to a front of the rigid uni-body chassis 51. The rear wheels 56 and 57 are substantially larger than the front wheels 58 and 59 to allow easy movement in thick turf. The front wheels 58 and 59 are rigidly fixed to the rigid uni-body chassis 51, however, other types of front wheels such as caster wheels can be used. A guide bar 60 is attached to the rigid uni-body chassis 51 to allow easy movement of the Lawn and Garden Sprayer 50. Nozzles 61 and 62 are mounted to the front end of the rigid uni-body chassis 51 providing a 24 inch overlapping spray, and a wand 63 is mounted to the guide bar 60 for spraying trees, shrubs, and flowers.

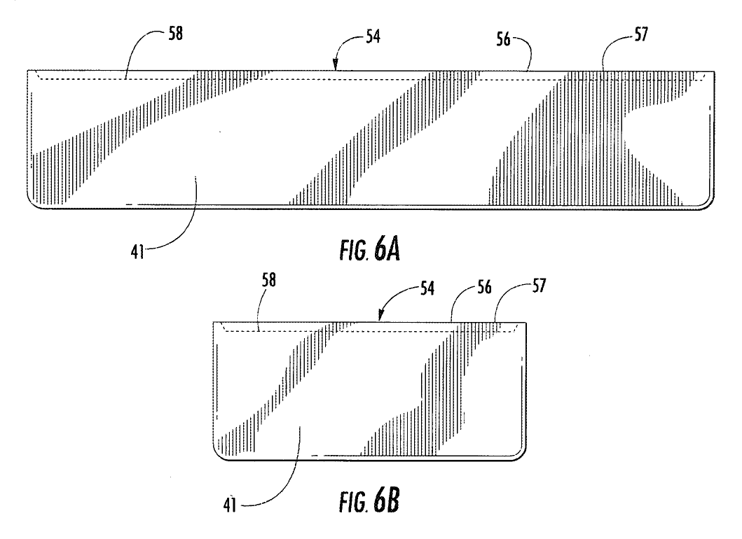

Referring specifically to FIGS. 6A and 6B, the rigid uni-body chassis 51 has a front side 64, a rear side 66, a left side 67, a right side 68, and a top edge 69 defining an interior cavity 70 for supporting a container 52, a suction/discharge device 53, and a power supply 54. A female strengthening ring 71 is formed in the top edge 69 for mating with a male strengthening ring.

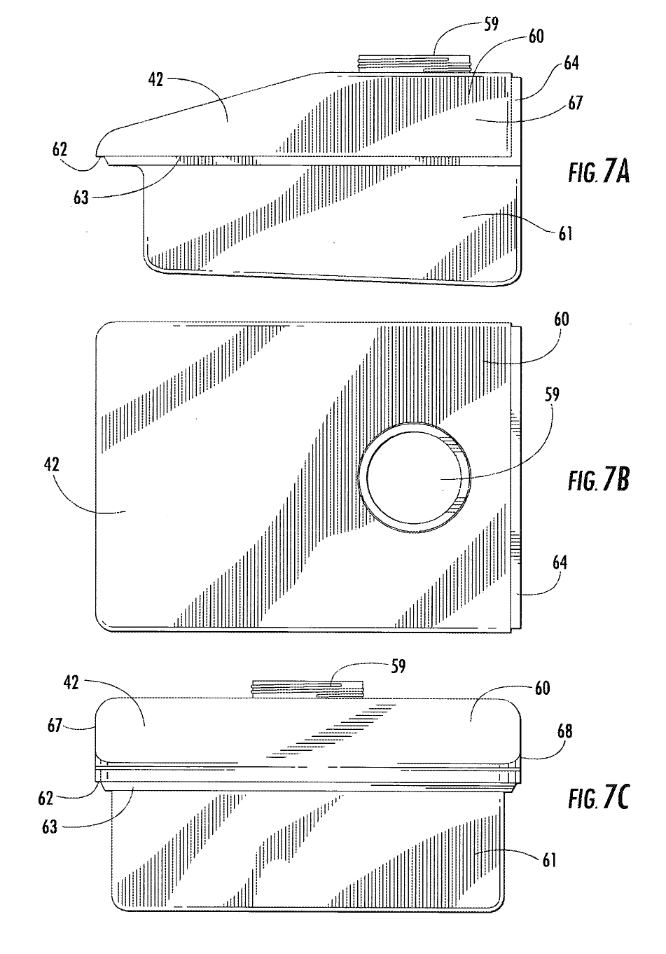

Referring specifically to FIGS. 7A, 7B, and 7C, the container 52 has a fill cap 72 for filling the container 52 with a water soluble fertilizer located on the top of the container 52. The top half 73 of the container 52 is larger than the bottom half 74 of the container 52 permitting the bottom half 74 to fit within the interior cavity 70 of the rigid uni-body chassis 51 and providing a ledge with a male strengthening ring 76 for mating with the female strengthening ring 71 of the rigid uni-body chassis 51. On the rear end of the container 52 located on the top half 73 a ledge 77 is formed for providing an area where a back cover can rest. The ledge 77 runs from the male strengthening ring 76 located at the bottom of the top half 73 of the container 52 up a left side 78 of the top half 73 across the top of the top half 73 and down a right side 79 of the top half 73 to the male strengthening ring 76.

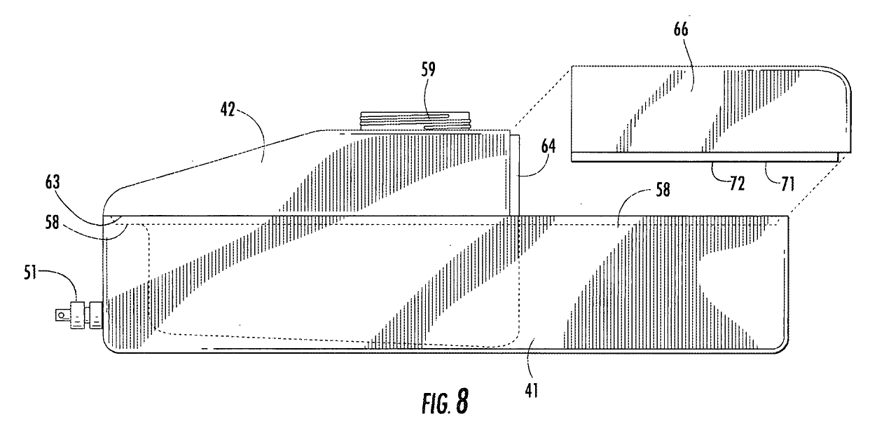

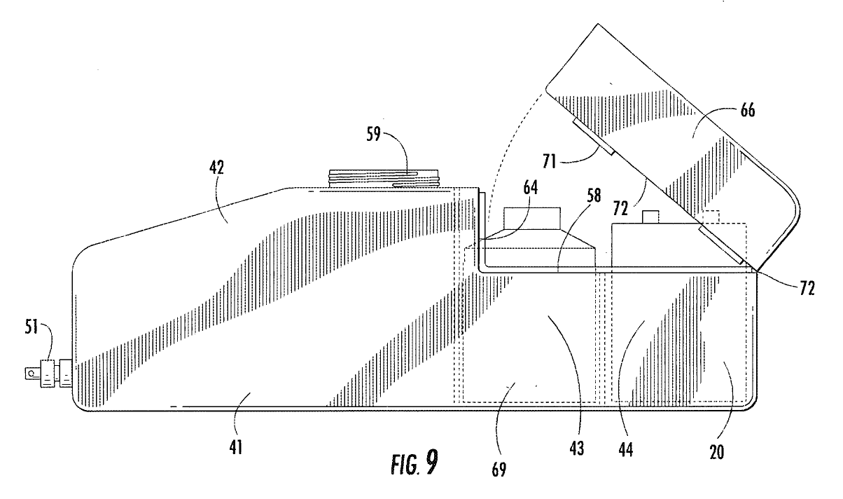

Referring specifically to FIGS. 8 and 9, the container 52 nests within the rigid uni-body chassis 51. The male strengthening ring 76 of the container 52 mates with the female strengthening ring 71 of the rigid uni-body chassis 51 providing a precise fit. A back cover 80 is used to cover the pump compartment 81 and the battery compartment 82. The back cover 80 has a male strengthening ring 83 along a bottom edge 84 of the back cover 80. The male strengthening ring 83 mates with the female strengthening ring 71 of the rigid uni-body chassis 51 providing a precise fit. The back cover 80 also matches up with the ledge 76 along the rear end of the container 52 providing a flush and uniform fit. The back cover 80 is attached to the rigid uni-body chassis 51 by a hinged connection 86 allowing easy access to the pump 53 and battery 54.

A lawn and garden sprayer has been described above. Various details of the invention may be changed without departing from its scope. Furthermore, the foregoing description of the preferred embodiment of the invention and the best mode of practicing the invention are provided for the purpose of illustration only and not for the purpose of limitation—the invention being defined by the claims.

I claim:

1. A lawn and garden sprayer, comprising:
(a) a rigid frame chassis, wherein said chassis has a right horizontal support connected to a right end of a front horizontal support and a right end of a rear horizontal support, a left horizontal support connected to a left end of a front horizontal support and a left end of a rear horizontal support, a guide bar connected to said right support, said left support, and said rear support by at least one vertical support;
(b) a plurality of rear wheels connected to a rear end of said chassis and a plurality of front wheels connected to a front end of said chassis;
(c) a power supply, a suction/discharge device, and a container supported by said chassis; and
(d) first and second means for spraying a liquid substance.

2. The lawn and garden sprayer according to claim 1, wherein said rear wheels are substantially larger than said front wheels to allow easy movement of said sprayer.

3. The lawn and garden sprayer according to claim 1, wherein said power supply is a battery and said suction/discharge device is a pump.

4. The lawn and garden sprayer according to claim 1, wherein said suction/discharge device is connected to said container by at least one hose.

5. The lawn and garden sprayer according to claim 1, wherein said first means for spraying a liquid comprises at least one spray nozzle.

6. The lawn and garden sprayer according to claim 6, wherein said spray nozzle is attached to said front end of said chassis and connected to said suction/discharge device by at least one hose.

7. The lawn and garden sprayer according to claim 1, wherein said second means for spraying a liquid comprises at least one spray wand.

8. The lawn and garden sprayer according to claim 7, wherein said spray wand is connected to said suction/discharge device by at least one hose.

9. A lawn and garden sprayer, comprising:
(a) a rigid uni-body chassis, wherein said chassis has a front side, a rear side, a right side, and a left side defining an interior cavity for supporting a container, a power supply, and a suction/discharge device;
(b) a female strengthening ring defined by a top edge of said chassis;
(c) a guide bar connected to said right side and said left side of said chassis;
(d) a plurality of rear wheels connected to a rear end of said chassis and a plurality of front wheels connected to a front end of said chassis; and
(e) first and second means for spraying a liquid substance.

10. The lawn and garden sprayer according to claim 9, wherein said container has a male strengthening ring for mating with said female strengthening ring of said chassis.

11. The lawn and garden sprayer according to claim 9, wherein said power supply is a battery and said suction/discharge device is a pump.

12. The lawn and garden sprayer according to claim 9, wherein said rear wheels are substantially larger than said front wheels to allow easy movement of said sprayer.

13. The lawn and garden sprayer according to claim 9, wherein said suction/discharge device is connected to said container by at least one hose.

14. The lawn and garden sprayer according to claim 9, wherein said first means for spraying a liquid comprises at least one spray nozzle.

15. The lawn and garden sprayer according to claim 14, wherein said spray nozzle is attached to said front end of said chassis and connected to said suction/discharge device by at least one hose.

16. The lawn and garden sprayer according to claim 9, wherein said second means for spraying a liquid comprises at least one spray wand.

17. The lawn and garden sprayer according to claim 16, wherein said spray wand is connected to said suction/discharge device by at least one hose.

18. The lawn and garden sprayer according to claim 9, further comprising a back cover for covering said power supply and said suction/discharge device within said chassis.

19. The lawn and garden sprayer according to claim 18, wherein said back cover has a male strengthening ring for mating with said female strengthening ring of said chassis.
